(19) United States
(12) Patent Application Publication
(10) Pub. No.: US 2022/0278782 A1
(43) Pub. Date: Sep. 1, 2022

(54) METHOD AND APPARATUS FOR DOWNLINK DECODING, USER EQUIPMENT, AND STORAGE MEDIUM

(71) Applicant: SPREADTRUM COMMUNICATIONS (SHANGHAI) CO., LTD., Shanghai (CN)

(72) Inventor: Xia TAN, Shanghai (CN)

(21) Appl. No.: 17/746,133

(22) Filed: May 17, 2022

Related U.S. Application Data
(63) Continuation of application No. PCT/CN2020/113298, filed on Sep. 3, 2020.

(30) Foreign Application Priority Data
Nov. 18, 2019 (CN) 201911126879.3

(51) Int. Cl. H04L 1/22; H04W 72/04; H04L 1/18; H04B 7/06

(52) U.S. Cl. CPC H04L 1/22; H04W 72/042; H04L 1/1819; H04B 7/0608

(57) ABSTRACT

A method and apparatus for downlink decoding, a user equipment (UE), and a storage medium are provided. The method includes: receiving at least one layer of downlink data; for each of multiple downlink antennas, filtering antenna data corresponding to the downlink antenna according to channel quality corresponding to the downlink antenna and a quantity of layers of the downlink data, on condition that the quantity of layers of the downlink data is less than a quantity of the multiple downlink antennas; and decoding retained antenna data after the filtering.

### CROSS-REFERENCE TO RELATED APPLICATION(S)

This application is a continuation of International Application No. PCT/CN2020/113298, filed Sep. 3, 2020, which claims priority to Chinese Patent Application No. 201911126879.3, filed Nov. 18, 2019, the entire disclosures of which are hereby incorporated by reference.

### TECHNICAL FIELD

This disclosure relates to the field of communication technology, and in particular to a method and apparatus for downlink decoding, a user equipment (UE), and a storage medium.

### BACKGROUND

At present, in a mobile communication system, a user equipment (UE) mainly uses multiple antennas to receive downlink data transmitted by a network-side device.

On condition that the quantity of layers of the downlink data transmitted by the network-side device is less than the quantity of downlink antennas, a power adjustment module of the UE will amplify power gains of other downlink antennas, so that noise of other downlink antennas will be amplified. During a downlink decoding process, the UE will combine useful downlink data and the antenna data containing amplified noise, and use the averaging-and-combining decoding algorithm for decoding.

However, in the above method, the UE will use antenna data with poor performance or amplified noise during the downlink decoding process, leading to a poor downlink decoding performance.

### SUMMARY

In a first aspect, a method for downlink decoding is provided. The method is applied to a UE and includes: receiving at least one layer of downlink data; for each of multiple downlink antennas, filtering antenna data corresponding to the downlink antenna according to channel quality corresponding to the downlink antenna and a quantity of layers of the downlink data, on condition that the quantity of layers of the downlink data is less than a quantity of the multiple downlink antennas; and decoding retained antenna data after the filtering.

In a second aspect, a UE is provided. The UE includes a transceiver, a processor and a memory configured to store processor-executable instructions which, when executed by the processor, cause the UE to implement the method of the first aspect.

In a third aspect, a non-transitory computer-readable storage medium is provided. The non-transitory computer-readable storage medium stores computer program instructions which, when executed by a computer, cause the computer to implement the method of the first aspect.

### BRIEF DESCRIPTION OF THE DRAWINGS

The accompanying drawings, which are incorporated in and constitute a part of the specification, illustrate exemplary embodiments, features, and aspects of the disclosure and serve to explain principles of the disclosure, together with the description.

FIG. 1 is schematic structural diagram of a mobile communication system provided in embodiments of the disclosure.

FIG. 2 is a flowchart of a method for downlink decoding provided in embodiments of the disclosure.

FIG. 3 is a flowchart of a method for downlink decoding provided in embodiments of the disclosure.

FIG. 4 is schematic structural diagram of an apparatus for downlink decoding provided in embodiments of the disclosure.

FIG. 5 is schematic structural diagram of a user equipment provided in embodiments of the disclosure.

### DETAILED DESCRIPTION

Various exemplary embodiments, features, and aspects of the present disclosure will be described in detail below with reference to the accompanying drawings. The same reference numbers in the accompanying drawings denote elements having the same or similar functions. While various aspects of the embodiments are illustrated in the drawings, the drawings are not necessarily drawn to scale unless otherwise indicated.

The word “exemplary” used herein means “serving as an example, embodiment, or illustration.” Any embodiment described herein as “exemplary” is not necessarily to be construed as preferred or advantageous over other embodiments.

It should be understood that the term “and/or” herein is only an association relationship to describe associated objects, indicating that there can be three kinds of relationships, for example, A and/or B can mean that A exists alone, A and B exist at the same time, or B exists alone. In addition, the character “/” herein indicates that the related objects are in an “or” relationship.

The term “a plurality of” or “multiple” in embodiments of the present disclosure refers to two or more.

The descriptions of the first, second, etc. in embodiments of the present disclosure are only for the purpose of illustrating and distinguishing the described objects, and have no order, nor do they represent a special limitation on the number of devices in the embodiments of the present disclosure, and cannot constitute any limitations of embodiments of the present disclosure.

The term “coupled” in embodiments of the present disclosure refers to various connection modes such as direct connection or indirect connection, so as to realize communication between devices, which is not limited in embodiments of the present disclosure.

In addition, in order to better illustrate the present disclosure, numerous specific details are given in the following detailed description. It will be understood by those skilled in the art that the present disclosure may be practiced without certain specific details. In some examples, methods, means, components, and circuits well known to those skilled in the art have not been described in detail so as not to obscure the subject matter of the present disclosure.

A user equipment (UE) usually adopts a downlink average-combining decoding algorithm during a downlink decoding process, and antenna data with poor performance or amplified noise will likely to be used, resulting in poor downlink decoding performance, which cannot meet the actual requirements.

To this end, embodiments of this disclosure provide a method and apparatus for downlink decoding, a UE, and a storage medium. In the embodiments of this disclosure, on condition that the quantity of layers of received downlink data is less than the quantity of multiple downlink antennas, the UE can filter antenna data corresponding to each of the multiple downlink antennas according to channel quality corresponding to each of the multiple downlink antennas and the quantity of layers of the downlink data, and decode antenna data retained after the filtering. In this way, a situation where antenna data of all downlink antennas would be used for average-combining decoding, which may likely cause using of antenna data with poor performance or amplified noise, can be avoided during the downlink decoding process, thus improving downlink decoding performance.

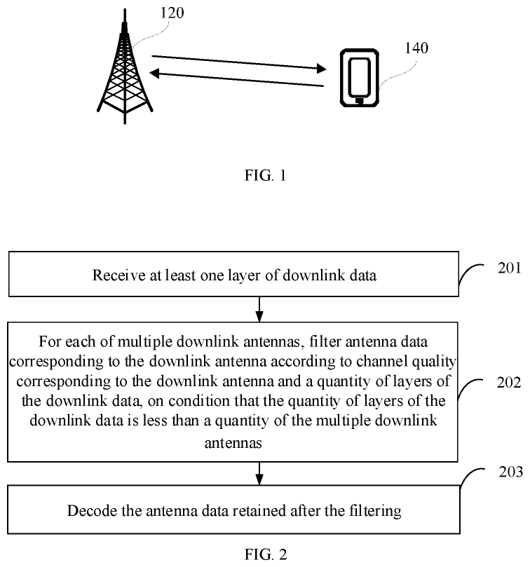

Referring to FIG. 1, FIG. 1 is a schematic structural diagram of a mobile communication system provided in embodiments of the disclosure. The mobile communication system can be a Long Term Evolution (LTE) system, or a fifth-generation (5G) system. The 5G system is also called a New Radio (NR) system. The mobile communication system can also be a next-generation mobile communication system of 5G, which is not limited in this embodiment.

Optionally, the mobile communication system is applicable to different network architectures, including but not limited to a relay network architecture, a dual link architecture, a V2X architecture, and the like. The mobile communication system includes an access network device 120 and a UE 140.

The access network device 120 may be a base station (BS), and may also be referred to as a base station device, which is deployed in a radio access network (RAN) to provide a wireless communication function. For example, a device that provides base station functions in 2G networks includes a base transceiver station (BTS), a device that provides base station functions in 3G networks includes a Node B (NodeB), a device that provides base station functions in 4G networks includes an evolved Node B (evolved NodeB, eNB), a device that provides base station functions in wireless local area networks (WLAN) is an access point (AP), and a device that provides base station functions in the 5G system is a gNB and a continuously evolved Node B (ng-eNB). The access network device 120 in embodiments of the present disclosure also includes a device that provides base station functions in a new communication system in the future. The specific implementation of the access network device 120 is not limited in embodiments of the present disclosure. The access network device may further include a home eNodeB (Home eNB, HeNB), a relay, a pico base station (Pico), and the like.

A base station controller is a device that manages base stations, such as a base station controller (BSC) in the 2G network, a radio network controller (RNC) in the 3G network, or a device that controls and manages base stations in a new communication system in the future.

The network in embodiments of the present disclosure is a communication network that provides communication services for the UE 140, and the network-side device includes a base station of the wireless access network, a base station controller of the wireless access network, or a device on the core network side.

The core network can be an evolved packet core (EPC), a 5G core network (5GCN), or a new core network in future communication systems. The 5G Core Network consists of a set of devices and includes an access and mobility management function (AMF) that implements functions such as mobility management, a user plane function (UPF) that provides functions such as packet routing and forwarding and quality of service (QoS) management, a session management function (SMF) that provides functions such as session management and IP address allocation and management, and the like. EPC can include an MME that provides functions such as mobility management and gateway selection, a serving gateway (S-GW) that provides functions such as packet forwarding, and a PDN gateway (S-GW) that provides functions such as terminal address allocation and rate control.

The access network device 120 and the UE 140 establish a wireless connection through a wireless air interface. Optionally, the wireless air interface is a wireless air interface based on a 5G standard, for example, the wireless air interface is NR. Optionally, the wireless air interface may also be a wireless air interface based on a 5G next-generation mobile communication network technology standard. Optionally, the wireless air interface can also be a wireless air interface based on the 4G standard (LTE system). The access network device 120 may receive uplink data transmitted by the UE 140 through the wireless connection.

The UE 140 may refer to a device that performs data communication with the access network device 120. The UE 140 may communicate with one or more core networks via a radio access network. The UE 140 may be a user device, an access terminal equipment, a subscriber unit, a subscriber station, a station, a mobile station (MS), a remote station, a remote terminal equipment, a mobile equipment, a terminal equipment, a wireless communication equipment, a user agent, or a user apparatus in various forms. The UE 140 may also be a cellular phone, a cordless phone, a session initiation protocol (SIP) phone, a wireless local loop (WLL) station, a personal digital assistant (PDA), a wireless communication-enabled handheld device, a computing device or other processing devices connected to a wireless modem, an in-vehicle device, a wearable device, a UE in a future 5G network or a UE in a future evolved public land mobile network (PLMN), etc., which is not limited in this embodiment. The UE 140 may receive downlink data transmitted by the access network device 120 through a wireless connection with the access network device 120.

It should be noted that when the mobile communication system illustrated in FIG. 1 adopts the 5G system or the next-generation mobile communication system of 5G, the above-mentioned network elements may have different names in the 5G system or the next-generation mobile communication system of 5G, but have the same or similar functions, which are not limited in embodiments of the present disclosure.

It should also be noted that the mobile communication system illustrated in FIG. 1 may include multiple access network devices 120 and/or multiple UEs 140, and FIG. 1 exemplarily illustrates one access network device 120 and one UE 140, but this is not limited in embodiments of the present disclosure.

Referring FIG. 2, FIG. 2 illustrates a flowchart of a method for downlink decoding provided in embodiments of the disclosure. In this embodiment, the method is exemplarily applied to the UE 140 illustrated in FIG. 1. The method includes the following steps.

Step 201, the UE receives at least one layer of downlink data.

A network-side device transmits the downlink data to the UE. Correspondingly, the UE receives the downlink data transmitted by the network-side device. The downlink data includes at least one layer of the downlink data.

Optionally, the at least one layer of downlink data is downlink data transmitted on at least one transmission layer.

The UE receives the downlink data transmitted by the network-side device over a downlink channel.

Optionally, the downlink channel is a physical downlink control channel (PDCCH), an enhanced physical downlink control channel (EPDCCH), a physical downlink shared channel (PDSCH), or a downlink channel in the 5G system, which is not limited in this embodiment.

Step 202, for each of multiple downlink antennas, the UE filters antenna data corresponding to the downlink antenna according to channel quality corresponding to the downlink antenna and a quantity of layers of the downlink data, on condition that the quantity of layers of the downlink data is less than a quantity of the multiple downlink antennas.

Optionally, the quantity of layers of downlink data also refers to the number of transmission layers of the downlink data. The quantity of layers of downlink data is the number of transmission layers of the downlink data received over the downlink channel. For example, when the downlink channel is PDCCH, the number of transmission layers of the downlink data is 1. For another example, when the downlink channel is PDSCH, the number of transmission layers of the downlink data is 1, 2, or 3. This embodiment does not limit the specific value of the quantity of layers of downlink data.

The downlink antenna is used for receiving the downlink data. The quantity of downlink antennas is the quantity of antennas supported by the UE. That is, the quantity of downlink antennas is the quantity of antennas used in the UE to receive the downlink data.

Optionally, after receiving the at least one layer of downlink data, the UE determines whether the quantity of layers of the downlink data is less than the quantity of the downlink antennas. If the quantity of layers of the downlink data is less than the quantity of the downlink antennas, the UE filters the antenna data corresponding to each of the multiple downlink antennas according to channel quality corresponding to each of the multiple downlink antennas and the quantity of layers of the downlink data. If the quantity of layers of the downlink data is greater than the quantity of the downlink antennas, the process is ended.

Optionally, the UE obtains retained antenna data by filtering the antenna data corresponding to each of the multiple downlink antennas according to channel quality corresponding to each of the multiple downlink antennas and the quantity of layers of the downlink data

Step 203, the UE decodes the antenna data retained after the filtering.

The UE obtains decoded data by decoding the antenna data retained after the filtering. Optionally, the retained antenna data includes antenna data of at least one antenna, that is, at least one piece of antenna data.

It should be noted that, for some related terms involved in embodiments of the disclosure, for example, PDCCH, EPDCCH, PDSCH, etc., reference may be made to corresponding related descriptions in 3GPP protocols, which will not be repeated herein.

In summary, in embodiments of this disclosure, on condition that the quantity of layers of received downlink data is less than the quantity of multiple downlink antennas, the UE can filter antenna data corresponding to each of the multiple downlink antennas according to channel quality corresponding to each of the multiple downlink antennas and the quantity of layers of the downlink data, and decode retained antenna data after the filtering. In this way, the condition that antenna data of all downlink antennas would be used for average-combining decoding, which may likely cause using of antenna data with poor performance or amplified noise, can be avoided during the downlink decoding process, thus improving downlink decoding performance.

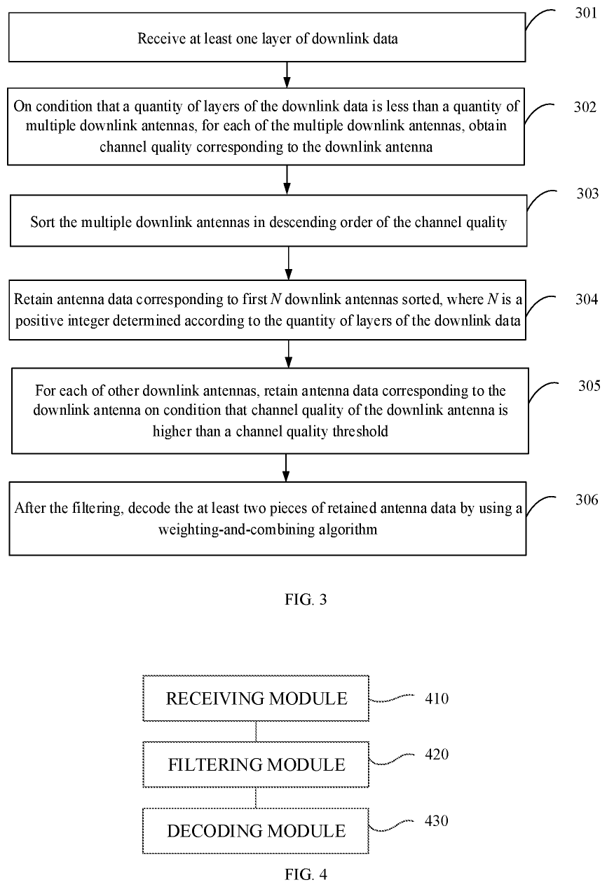

Referring to FIG. 3, FIG. 3 illustrates a flowchart of a method for downlink decoding provided in embodiments of the disclosure. In this embodiment, the method for downlink decoding is exemplarily applied to the UE 140 illustrated in FIG. 1. The method for downlink decoding includes the following.

Step 301, the UE receives at least one layer of downlink data.

It should be noted that, for the process of the UE receiving at least one layer of downlink data, reference may be made to the relevant details in the foregoing embodiments, which will not be repeated herein.

Step 302, on condition that a quantity of layers of the downlink data is less than a quantity of multiple downlink antennas, for each of the multiple downlink antennas, the UE obtains channel quality corresponding to the downlink antenna.

Optionally, after receiving the at least one layer of downlink data, the UE determines whether the quantity of layers of the downlink data is less than the quantity of the multiple downlink antennas. If the quantity of layers of the downlink data is less than the quantity of the downlink antennas, the UE obtains the channel quality corresponding to each of the multiple downlink antennas. If the quantity of layers of the downlink data is greater than the quantity of the downlink antennas, the process is ended.

The multiple downlink antennas are at least two downlink antennas used for receiving the downlink data in the UE. For example, the multiple downlink antennas are 4 downlink antennas. This embodiment does not limit the specific value of the quantity of the multiple downlink antennas.

Step 303, the UE sorts the multiple downlink antennas in descending order of the channel quality.

The UE sorts the multiple downlink antennas in descending order of the channel quality to obtain the multiple downlink antennas after sorted.

Step 304, the UE retains antenna data corresponding to first N downlink antennas sorted, where N is a positive integer determined according to the quantity of layers of the downlink data.

The UE determines the value of N according the quantity of layers of the downlink data, and retains the top N downlink antennas after sorted, according to the multiple sorted downlink antennas.

Optionally, N equals to the quantity of layers of the downlink data.

In an example, the quantity of layers of the downlink data is 1, so that the value of N is determined to be 1. As such, the UE retains antenna data of the first downlink antenna after sorted.

Step 305, for each of other downlink antennas, the UE retains antenna data corresponding to the downlink antenna on condition that channel quality of the downlink antenna is higher than a channel quality threshold.

The above-mentioned other downlink antennas are downlink antennas other than the first N downlink antennas among the multiple downlink antennas.

Optionally, downlink antennas other than the first N downlink antennas among the multiple downlink antennas are the above-mentioned other downlink antennas. For each of other downlink antennas, the UE determines whether the channel quality of the downlink antenna is higher than the channel quality threshold. If the channel quality of the downlink antenna is higher than the channel quality threshold, the antenna data of the downlink antenna is retained. If the channel quality of the downlink antenna is lower than or equal to the channel quality threshold, the antenna data of the downlink antenna is filtered out.

Optionally, at least two downlink antennas in the multiple downlink antennas have different channel quality thresholds. Alternatively, any two downlink antennas in the multiple downlink antennas have a same channel quality threshold.

Optionally, the channel quality threshold of each downlink antenna is pre-configured, or determined according to performance (ability) of a decoder of the downlink antenna and/or a modulation order corresponding to the downlink antenna. In one possible implementation, for each of other downlink antennas, before the UE determines whether the channel quality of the downlink antenna is higher than the channel quality threshold, the UE determines the channel quality threshold according to the performance of the decoder of the downlink antenna.

Optionally, the channel quality threshold of the downlink antenna indicates the performance of the decoder of the downlink antenna. In an example, the channel quality threshold is positively correlated with the performance of the decoder of the downlink antenna. That is, the better the performance of the decoder of the downlink antenna, the higher the corresponding channel quality threshold.

In some implementations, for each of other downlink antennas, before the UE determines whether the channel quality of the downlink antenna is higher than the channel quality threshold, the UE determines the channel quality threshold according to the modulation order corresponding to the downlink antenna.

Optionally, the modulation order corresponding to the downlink antenna is used to characterize a current modulation mode of the downlink antenna. For example, if the modulation mode is quadrature phase shift keying (QPSK), the modulation order is 2. If the modulation mode is quadrature amplitude modulation (QAM) with 16 symbols, the modulation order is 4. If the modulation mode is QAM with 64 symbols, the modulation order is 6.

Optionally, the channel quality threshold of the downlink antenna indicates the modulation order corresponding to the downlink antenna. In an example, the channel quality threshold is positively correlated with the modulation order of the downlink antenna. That is, the higher the modulation order of the downlink antenna, the higher the corresponding channel quality threshold.

In some implementations, for each of other downlink antennas, before the UE determines whether the channel quality of the downlink antenna is higher than the channel quality threshold, the UE determines the channel quality threshold according to the performance of the decoder of the downlink antenna and the modulation order corresponding to the downlink antenna.

Optionally, the channel quality threshold of the downlink antenna indicates the performance of the decoder of the downlink antenna and the modulation order corresponding to the downlink antenna. In an example, the channel quality threshold is positively correlated with the performance of the decoder of the downlink antenna and the modulation order of the downlink antenna.

It should be noted that step 305 may be or may not be performed. That is, after step 304 is completed, the UE may directly filter out, that is, not retain, antenna data of other downlink antennas, and proceed to step 306, which is not limited in this embodiment.

Step 306, after the filtering, the UE decodes the at least two pieces of retained antenna data by using a weighting-and-combining algorithm.

Optionally, when the retained antenna data includes retained antenna data of at least two downlink antennas, that is, at least two pieces of retained antenna data, the UE decodes the at least two pieces of retained antenna data using the weighting-and-combining algorithm.

Optionally, each of the at least two pieces of retained antenna data has a corresponding weighting factor that is pre-configured or determined according to channel quality corresponding to the downlink data, which is not limited in this embodiment. In the following, for each of the at least two pieces of retained antenna data, the weighting factor corresponding to the antenna data is exemplarily determined according to the channel quality corresponding to the antenna data.

In some implementations, the UE obtains weighting factors each corresponding to one of the at least two pieces of retained antenna data, where the weighting factors each indicate channel quality of a downlink antenna corresponding to the antenna data. Based on the weighting factors corresponding to the at least two pieces of retained antenna data, the UE decodes the at least two pieces of retained antenna data using the weighting-and-combining algorithm, to obtain decoded data.

Optionally, the weighting factor of the antenna data is positively correlated with the channel quality of the downlink antenna corresponding to the downlink data. That is, the higher the channel quality of the downlink antenna corresponding to the downlink data, the greater the corresponding weighting factor. The lower the channel quality of the downlink antenna corresponding to the downlink data, the smaller the corresponding weighting factor.

Optionally, the UE obtains the weighting factors each corresponding to one of the at least two pieces of retained antenna data as follows. For each of the at least two pieces of retained antenna data, the UE obtains channel quality of the downlink antenna corresponding to the retained antenna data, and determines the weighting factor corresponding to the retained antenna data according to channel quality of the at least two downlink antennas.

Optionally, among the at least two pieces of retained antenna data, first antenna data has a first weighting factor, and second antenna data has a second weighting factor. The first antenna data is one of the at least two pieces of retained antenna data. In case that channel quality of a downlink antenna corresponding to the first antenna data is higher than channel quality of a downlink antenna corresponding to the second antenna data, the first weighting factor is greater than the second weighting factor.

In an example, the UE receives one layer of downlink data, and there are 4 downlink antennas. In this case, the quantity of layer of the downlink data is less than the quantity of downlink antennas, so that channel quality corresponding to each of the 4 downlink antennas is obtained. The UE sorts the 4 downlink antennas in descending order and then retains antenna data T1 of the first downlink antenna after sorted. For the second downlink antenna after sorted, the UE determines that channel quality of the second downlink antenna is lower than a channel quality threshold THER0 of the second downlink antenna, and then filters out antenna data T2 of the second downlink antenna. For the third downlink antenna after sorted, the UE determines that channel quality of the third downlink antenna is lower than a channel quality threshold THER1 of the third downlink antenna, and then filters out antenna data T3 of the third downlink antenna. For the fourth downlink antenna after sorted, the UE determines that channel quality of the fourth downlink antenna is higher than a channel quality threshold THER2 of the fourth downlink antenna, and then retains antenna data T4 of the fourth downlink antenna. As such, antenna data T1 and antenna data T4 are retained. The channel quality corresponding to antenna data T1 is higher than the channel quality corresponding to antenna data T4. The UE then determines that a weighting factor of antenna data T1 is 0.8 and a weighting factor of antenna data T4 is 0.2 according to the channel quality corresponding to these two pieces of antenna data. Based on the weighting factor “0.8” of antenna data T1 and the weighting factor “0.2” of antenna data T4, the UE decodes antenna data T1 and antenna data T4 using the weighting-and-combining algorithm to obtain decoded data.

In summary, in embodiments of the disclosure, after the filtering, the UE decodes the at least two pieces of retained antenna data using the weighting-and-combining algorithm. In this way, antenna data filled with noise can be filtered out, and antenna data with poor performance can be diminished, so that downlink reception at the UE can have robustness, further improving performance of downlink decoding.

Apparatus embodiments of the disclosure are described in the following. For parts that are not described in detail in the apparatus embodiments, reference may be made to the technical details disclosed in the foregoing method embodiments.

Referring to FIG. 4, FIG. 4 is a schematic structural diagram of an apparatus for downlink decoding provided in embodiments of the disclosure. The apparatus for downlink decoding can be implemented as all or a part of the UE through software, hardware, or a combination thereof. The apparatus for downlink decoding includes a receiving module 410, a filtering module 420, and a decoding module 430.

The receiving module 410 is configured to receive at least one layer of downlink data.

The filtering module 420 is configured to filter, for each of multiple downlink antennas, antenna data corresponding to the downlink antenna according to channel quality corresponding to the downlink antenna and a quantity of layers of the downlink data, on condition that the quantity of layers of the downlink data is less than a quantity of the multiple downlink antennas.

The decoding module 430 is configured to decode retained antenna data after the filtering.

In some implementations, the filtering module 420 is further configured to: for each of the multiple downlink antennas, obtain the channel quality corresponding to the downlink antenna on condition that the quantity of layers of the downlink data is less than the quantity of the multiple downlink antennas; sort the multiple downlink antennas in descending order of the channel quality; and retain antenna data corresponding to first N downlink antennas sorted, where N is a positive integer determined according to the quantity of layers of the downlink data.

In some implementations, N equals to the quantity of layers of the downlink data.

In some implementations, the filtering module 420 is further configured to retain, for each of other downlink antennas other than the first N downlink antennas among the multiple downlink antennas, antenna data corresponding to the downlink antenna on condition that channel quality of the downlink antenna is higher than a channel quality threshold.

In some implementations, the apparatus further includes a determining module. The determining module is configured to determine, for each of other downlink antennas, the channel quality threshold according to at least one of performance of a decoder of the downlink antenna or a modulation order corresponding to the downlink antenna.

In some implementations, the retained antenna data includes at least two pieces of retained antenna data, and the decoding module 430 is further configured to decode the at least two pieces of retained antenna data by using a weighting-and-combining algorithm after the filtering.

In some implementations, the decoding module 430 is further configured to: for each of the at least two pieces of retained antenna data, obtain a weighting factor corresponding to the retained antenna data after the filtering, where the weighting factor indicates channel quality of a downlink antenna corresponding to the retained antenna data; and decode the at least two pieces of retained antenna data by using the weighting-and-combining algorithm to obtain decoded data, based on weighting factors corresponding to the at least two pieces of retained antenna data.

It should be noted that when the apparatus provided in the above embodiments realizes its functions, division of the above functional modules is merely used as an example for illustration. In practical applications, the above functions can be allocated to different functional modules according to actual needs. That is, content structures of the apparatus are divided into different functional modules to complete all or a part of the functions described above.

Regarding the apparatus in the above-mentioned embodiment, the specific manner in which each module performs the operation has been described in detail in the method embodiments, which will not be described in detail herein.

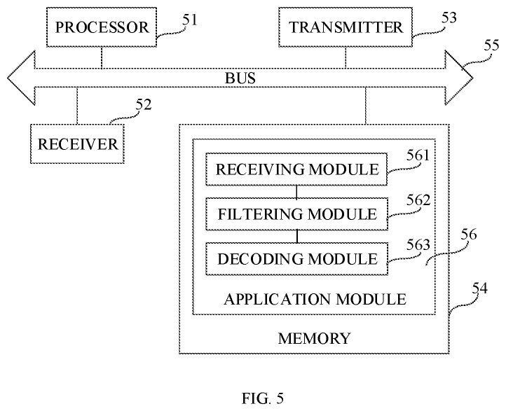

Referring to FIG. 5, FIG. 5 is a schematic structural diagram of a UE provided in embodiments of the disclosure. The UE may be the UE 140 in the mobile communication system illustrated in FIG. 1. In this embodiment, the UE is illustrated exemplarily as the UE in the LTE system or 5G system. The UE includes a processor 51, a receiver 52, a transmitter 53, a memory 54, and a bus 55. The memory 54 is coupled with the processor 51 via the bus 55.

The processor 51 includes one or more processing cores, and the processor 51 executes various functional applications and information processing by running software programs and modules.

The receiver 52 and the transmitter 53 may be implemented as one communication component, which may be a communication chip. The communication chip may include a receiving module, a transmitting module, a modulation and demodulation module, etc., for modulating and/or demodulating information, and receiving or transmitting this information via wireless signals.

The memory 54 may be configured to store instructions executable by the processor 51.

The memory 54 may store an application module 56 described with respect to at least one functions. The application module 56 may include a receiving module 561, a filtering module 562, and a decoding module 563.

The processor 51 is configured to execute the receiving module 561 to implement the functions related to the receiving steps in the above method embodiments. The processor 51 is further configured to execute the filtering module 562 to implement the functions related to the filtering steps in the above method embodiments. The processor 51 is further configured to execute the decoding module 563 to implement the functions related to the decoding steps in the above method embodiments.

Additionally, the memory 54 may be implemented by any type of volatile or non-volatile storage device or combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

The present disclosure may be a system, method, and/or computer program product. The computer program product may include a computer-readable storage medium having computer-readable program instructions loaded thereon for causing a processor to implement various aspects of the present disclosure.

The computer-readable storage medium may be a tangible device that can hold and store instructions for use by the device executing the instructions. The computer-readable storage medium may be, for example, but not limited to, an electrical storage device, a magnetic storage device, an optical storage device, an electromagnetic storage device, a semiconductor storage device, or any suitable combination thereof. More specific examples (non-exhaustive list) of computer readable storage media include: portable computer disks, hard disks, random access memory (RAM), read-only memory (ROM), erasable programmable read-only memory (EPROM or flash memory), static random access memory (SRAM), portable compact disk read-only memory (CD-ROM), digital versatile disk (DVD), memory sticks, floppy disks, mechanically coded devices, such as punch cards or raised structures in grooves with instructions stored thereon, and any suitable combination thereof. The computer-readable storage media, as used herein, are not to be interpreted as transient signals per se, such as radio waves or other freely propagating electromagnetic waves, electromagnetic waves propagating through waveguides or other transmission media (e.g., light pulses through fiber optic cables), or electrical signals transmitted through electrical wires.

The computer readable program instructions described herein may be downloaded to various computing/processing devices from the computer readable storage medium, or to an external computer or external storage device over a network such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in the computer-readable storage medium in each computing/processing device.

The computer program instructions for carrying out operations of the present disclosure may be assembly instructions, instruction set architecture (ISA) instructions, machine instructions, machine-dependent instructions, microcode, firmware instructions, state setting data, or source or object codes written in any combination of one or more programming languages, including object-oriented programming languages, such as Smalltalk, C++, etc., and conventional procedural programming languages, such as the “C” language or similar programming languages. The computer-readable program instructions may be executed entirely on the user's computer, partly on the user's computer, as a stand-alone software package, partly on the user's computer and partly on a remote computer, or entirely on the remote computer or server. In the case of a remote computer, the remote computer may be connected to the user's computer through any kind of network, including a local area network (LAN) or a wide area network (WAN), or may be connected to an external computer (e.g., using an Internet service provider to connect via the Internet). In some embodiments, custom electronic circuits, such as programmable logic circuits, field programmable gate arrays (FPGAs), or programmable logic arrays (PLAs), can be personalized by utilizing state information of computer-readable program instructions. The custom electronic circuits execute the computer-readable program instructions to implement various aspects of the present disclosure.

Aspects of the present disclosure are described herein with reference to flowchart and/or block diagrams of methods, apparatus (systems) and computer program products according to embodiments of the disclosure. It will be understood that each block of the flowchart and/or block diagrams, and combinations of blocks in the flowchart and/or block diagrams, can be implemented by the computer-readable program instructions.

These computer-readable program instructions may be provided to a processor of a general purpose computer, special purpose computer or other programmable data processing apparatus to produce a machine that causes the instructions, when executed by the processor of the computer or other programmable data processing apparatus, produce a means for implementing the functions/acts specified in one or more blocks of the flowchart and/or block diagrams. These computer-readable program instructions can also be stored in a computer-readable storage medium, these instructions causing a computer, programmable data processing apparatus and/or other equipment to operate in a specific manner, so that the computer-readable medium storing the instructions includes an article of manufacture including instructions for implementing various aspects of the functions/acts specified in one or more blocks of the flowchart and/or block diagrams.

The computer-readable program instructions can also be loaded onto a computer, other programmable data processing apparatus, or other equipment to cause a series of operational steps to be performed on the computer, other programmable data processing apparatus, or other equipment to produce a computer-implemented process, thereby causing instructions executing on the computer, other programmable data processing apparatus, or other device to implement the functions/acts specified in one or more blocks of the flowcharts and/or block diagrams.

The flowchart and block diagrams in the accompany drawings illustrate the architecture, functionality, and operation of possible implementations of systems, methods and computer program products according to various embodiments of the present disclosure. In this regard, each block in the flowchart or block diagrams may represent a module, segment, or portion of instructions, which includes one or more executable instructions for implementing the specified logical function(s). In some alternative implementations, the functions noted in the blocks may occur out of the order noted in the figures. For example, two blocks in succession may, in fact, be executed substantially concurrently, or the blocks may sometimes be executed in the reverse order, depending upon the functionality involved. It is also noted that each block of the block diagrams and/or flowchart, and combinations of blocks in the block diagrams and/or flowcharts, can be implemented in dedicated hardware-based systems that perform the specified functions or actions, or can be implemented in a combination of dedicated hardware and computer instructions.

Various embodiments of the present disclosure have been described above. The foregoing descriptions are exemplary, not exhaustive, and not limited by the disclosed embodiments. Numerous modifications and variations will be apparent to those of ordinary skill in the art without departing from the scope and spirit of the described embodiments. The terminology used herein was chosen to best explain the principles of the embodiments, the practical application or technical improvement over the technology in the marketplace, or to enable others of ordinary skill in the art to understand the embodiments disclosed herein.

What is claimed is:

1. A method for downlink decoding, applied to a user equipment (UE) and comprising:
receiving at least one layer of downlink data;
for each of a plurality of downlink antennas, filtering antenna data corresponding to the downlink antenna according to channel quality corresponding to the downlink antenna and a quantity of layers of the downlink data, on condition that the quantity of layers of the downlink data is less than a quantity of the plurality of downlink antennas; and
decoding retained antenna data after the filtering.

2. The method of claim 1, wherein filtering the antenna data corresponding to the downlink antenna according to the channel quality corresponding to the downlink antenna and the quantity of layers of the downlink data comprises:
obtaining the channel quality corresponding to the downlink antenna;
sorting the plurality of downlink antennas in descending order of the channel quality; and
retaining antenna data corresponding to first N downlink antennas sorted, N being a positive integer determined according to the quantity of layers of the downlink data.

3. The method of claim 2, wherein N equals to the quantity of layers of the downlink data.

4. The method of claim 2, further comprising:
for each of other downlink antennas other than the first N downlink antennas among the plurality of downlink antennas, retaining antenna data corresponding to the downlink antenna on condition that channel quality of the downlink antenna is higher than a channel quality threshold.

5. The method of claim 4, prior to retaining the antenna data corresponding to the downlink antenna on condition that the channel quality of the downlink antenna is higher than the channel quality threshold, further comprising:
determining the channel quality threshold according to at least one of performance of a decoder of the downlink antenna or a modulation order corresponding to the downlink antenna.

6. The method of claim 1, wherein the retained antenna data comprises at least two pieces of retained antenna data, and decoding the retained antenna data comprises:
decoding the at least two pieces of retained antenna data by using a weighting-and-combining algorithm.

7. The method of claim 6, wherein decoding the at least two pieces of retained antenna data using the weighting-and-combining algorithm comprises:
for each of the at least two pieces of retained antenna data, obtaining a weighting factor corresponding to the retained antenna data, wherein the weighting factor indicates channel quality of a downlink antenna corresponding to the retained antenna data; and
decoding the at least two pieces of retained antenna data by using the weighting-and-combining algorithm to obtain decoded data, based on weighting factors corresponding to the at least two pieces of retained antenna data.

8. A user equipment (UE) comprising:
a transceiver;
a processor; and
a memory configured to store processor-executable instructions which, when executed by the processor, cause the transceiver to:
receive at least one layer of downlink data;
the processor-executable instructions, when executed by the processor, further causing the processor to:
for each of a plurality of downlink antennas, filter antenna data corresponding to the downlink antenna according to channel quality corresponding to the downlink antenna and a quantity of layers of the downlink data, on condition that the quantity of layers of the downlink data is less than a quantity of the plurality of downlink antennas; and
decode retained antenna data after the filtering.

9. The UE of claim 8, wherein the processor-executable instructions executed by the processor to filter the antenna data corresponding to the downlink antenna according to the channel quality corresponding to the downlink antenna and the quantity of layers of the downlink data are executed by the processor to:
obtain the channel quality corresponding to the downlink antenna;
sort the plurality of downlink antennas in descending order of the channel quality; and
retain antenna data corresponding to first N downlink antennas sorted, N being a positive integer determined according to the quantity of layers of the downlink data.

10. The UE of claim 9, wherein N equals to the quantity of layers of the downlink data.

11. The UE of claim 9, wherein the processor-executable instructions, when executed by the processor, further cause the processor to:
for each of other downlink antennas other than the first N downlink antennas among the plurality of downlink antennas, retain antenna data corresponding to the downlink antenna on condition that channel quality of the downlink antenna is higher than a channel quality threshold.

12. The UE of claim 11, wherein the processor-executable instructions, when executed by the processor, further cause the processor to:
determine the channel quality threshold according to at least one of performance of a decoder of the downlink antenna or a modulation order corresponding to the downlink antenna.

13. The UE of claim 8, wherein the retained antenna data comprises at least two pieces of retained antenna data, and the processor-executable instructions executed by the processor to decode the retained antenna data are executed by the processor to:
decode the at least two pieces of retained antenna data by using a weighting-and-combining algorithm.

14. The UE of claim 13, wherein the processor-executable instructions executed by the processor to decode the at least two pieces of retained antenna data using the weighting-and-combining algorithm are executed by the processor to:
for each of the at least two pieces of retained antenna data, obtain a weighting factor corresponding to the retained antenna data, wherein the weighting factor indicates channel quality of a downlink antenna corresponding to the retained antenna data; and
decode the at least two pieces of retained antenna data by using the weighting-and-combining algorithm to obtain decoded data, based on weighting factors corresponding to the at least two pieces of retained antenna data.

15. A non-transitory computer-readable storage medium storing computer program instructions which, when executed by a computer, cause the computer to:
receive at least one layer of downlink data;
for each of a plurality of downlink antennas, filter antenna data corresponding to the downlink antenna according to channel quality corresponding to the downlink antenna and a quantity of layers of the downlink data, on condition that the quantity of layers of the downlink data is less than a quantity of the plurality of downlink antennas; and
decode retained antenna data after the filtering.

16. The non-transitory computer-readable storage medium of claim 15, wherein the computer program instructions executed by the computer to filter the antenna data corresponding to the downlink antenna according to the channel quality corresponding to the downlink antenna and the quantity of layers of the downlink data are executed by the computer to:
obtain the channel quality corresponding to the downlink antenna;
sort the plurality of downlink antennas in descending order of the channel quality; and
retain antenna data corresponding to first N downlink antennas sorted, N being a positive integer determined according to the quantity of layers of the downlink data.

17. The non-transitory computer-readable storage medium of claim 16, wherein N equals to the quantity of layers of the downlink data.

18. The non-transitory computer-readable storage medium of claim 16, wherein the computer program instructions, when executed by the computer, further cause the computer to:
for each of other downlink antennas other than the first N downlink antennas among the plurality of downlink antennas, retain antenna data corresponding to the downlink antenna on condition that channel quality of the downlink antenna is higher than a channel quality threshold.

19. The non-transitory computer-readable storage medium of claim 18, wherein the computer program instructions, when executed by the computer, further cause the computer to:
determine the channel quality threshold according to at least one of performance of a decoder of the downlink antenna or a modulation order corresponding to the downlink antenna.

20. The non-transitory computer-readable storage medium of claim 15, wherein the retained antenna data comprises at least two pieces of retained antenna data, and the computer program instructions executed by the computer to decode the retained antenna data are executed by the computer to:
decode the at least two pieces of retained antenna data by using a weighting-and-combining algorithm.
